(19) United States
(12) Patent Application Publication
(10) Pub. No.: US 2018/0208437 A1
(43) Pub. Date: Jul. 26, 2018

(54) ELEVATOR CAR LINING PANEL AND METHOD OF ASSEMBLING AN ELEVATOR CAR

(71) Applicant: Otis Elevator Company, Farmington, CT (US)

(72) Inventors: Romain Durand, Gien (FR); Stephane Blondel, Gien (FR)

(21) Appl. No.: 15/745,613

(22) PCT Filed: Jul. 23, 2015
(86) PCT No.: PCT/EP2015/066876

§ 371 Date: Jan. 17, 2018

(51) Int. Cl. B66B 11/02

(52) U.S. Cl. CPC B66B 11/0253; B66B 11/0233; B66B 11/02

(57) ABSTRACT

An elevator car lining panel (81-90), which is configured to be attached to at least one structural panel (41-49) of an elevator car (2), includes at least one first connection portion (10), which is configured for connecting with at least one corresponding second connection portion (18) of an adjacent elevator car lining panel (81-90) in order to fix two adjacent elevator car lining panels (81-90) with each other. The at least one first connection portion (10) is provided with a fixing structure which allows for fixing the elevator car lining panel (81-90) to an adjacent structural panel (41-49) of the elevator car (2).

The invention relates to an elevator car lining panel which is configured to be attached to at least one structural panel of an elevator car, and to a method of assembling an elevator car using such elevator car lining panels.

Elevator cars may be provided with a plurality of elevator car panels arranged inside an outer supporting frame. The elevator car panels may have a sandwich structure comprising a foam in between an inner and an outer decking. The inner decking may be laminated with a decor layer. Such elevator car panels may be fixed to the outer frame of the elevator car by means of double-T-bars attached to the frame.

It would be beneficial to facilitate the installation of the panels without considerably increasing their weight.

According to an exemplary embodiment of the invention, an elevator car lining panel, which is configured to be attached to at least one structural panel of an elevator car, comprises at least one first connection portion. The at least one first connection portion is configured for connecting with at least one corresponding second connection portion of an adjacent elevator car lining panel for fixing two adjacent elevator car lining panels to each other. The at least one first connection portion comprises a fixing structure which is configured for fixing the lining panel to an adjacent structural panel of the elevator car.

An elevator car according to an exemplary embodiment of the invention comprises at least one structural panel and at least one elevator car lining panel according to an exemplary embodiment of the invention. The at least one elevator car lining panel is attached to the at least one structural panel of the elevator car.

A method of assembling an elevator car according to an exemplary embodiment of the invention comprises the steps of:
a) assembling a plurality of structural panels forming an elevator cabin;
b) attaching a first elevator car lining panel according to an exemplary embodiment of the invention to at least one of the structural panels; and
c) connecting a second elevator car lining panel according to an exemplary embodiment of the invention with the first elevator car lining panel and attaching the second elevator car lining panel to at least one of the structural panels.

Elevator car lining panels according to exemplary embodiments of the invention may be installed fast and easily by joining corresponding connection portions of adjacent elevator car lining panels and fixing the first connection portion of the elevator car lining panel to a corresponding (adjacent) structural panel of the elevator car. This allows for installing the elevator car lining panels much faster and easier than conventional methods.

Exemplary embodiments of the invention are described in more detail with respect to the enclosed figures.

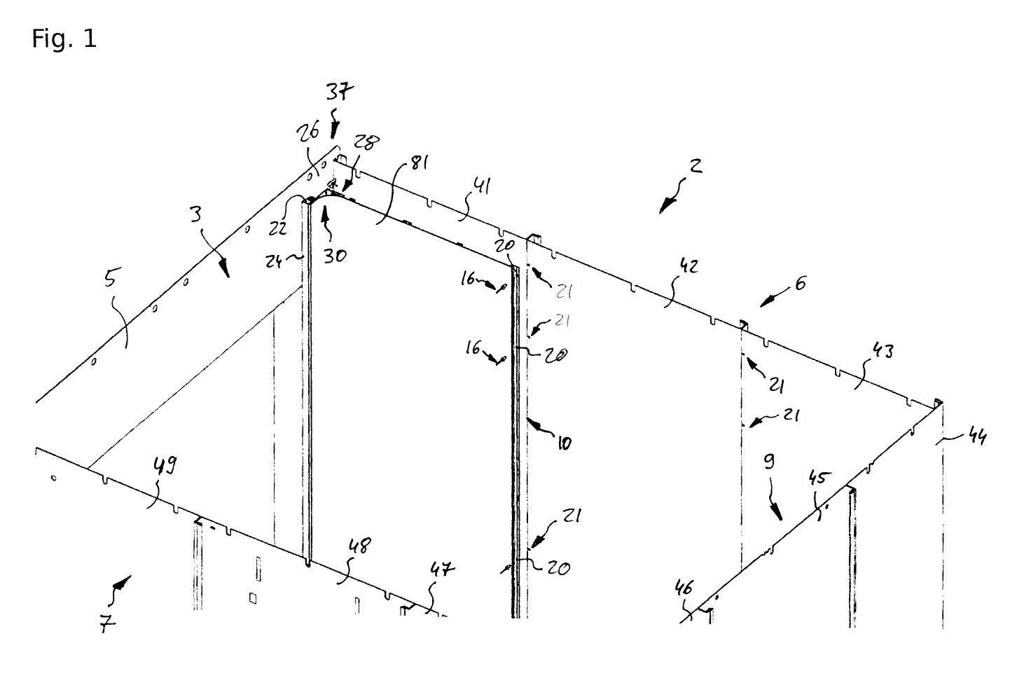

FIG. 1 shows a first step of installing elevator car lining panels according to an exemplary embodiment of the invention inside an elevator car.

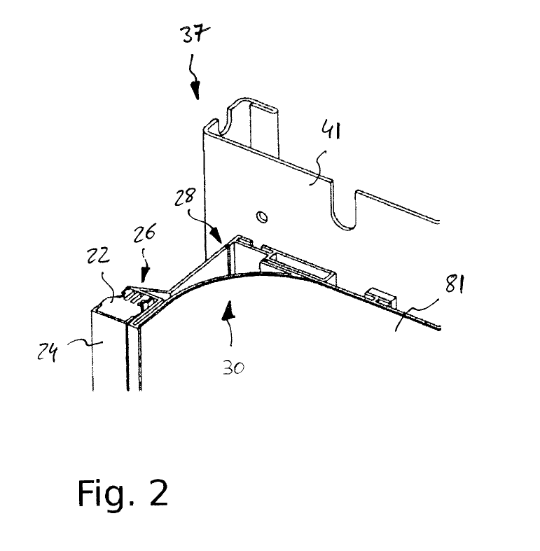

FIG. 2 shows an enlarged view of a corner portion of the elevator car.

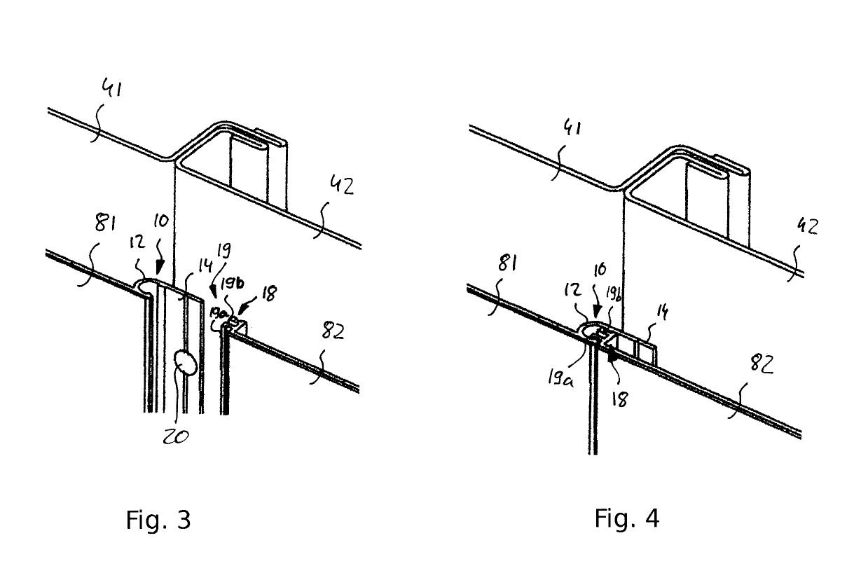

FIG. 3 shows an enlarged view of two adjacent elevator car lining panels.

FIG. 4 shows an enlarged view of two adjacent elevator car lining panels connected to each other.

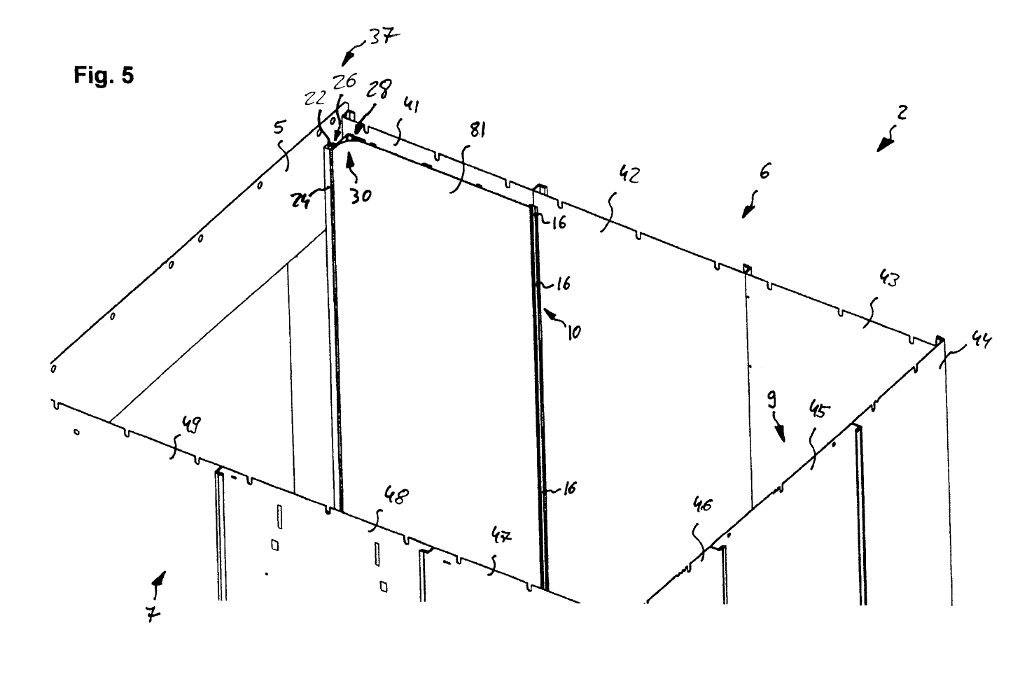

FIG. 5 shows a second step of installing elevator car lining panels according to an exemplary embodiment of the invention inside an elevator car.

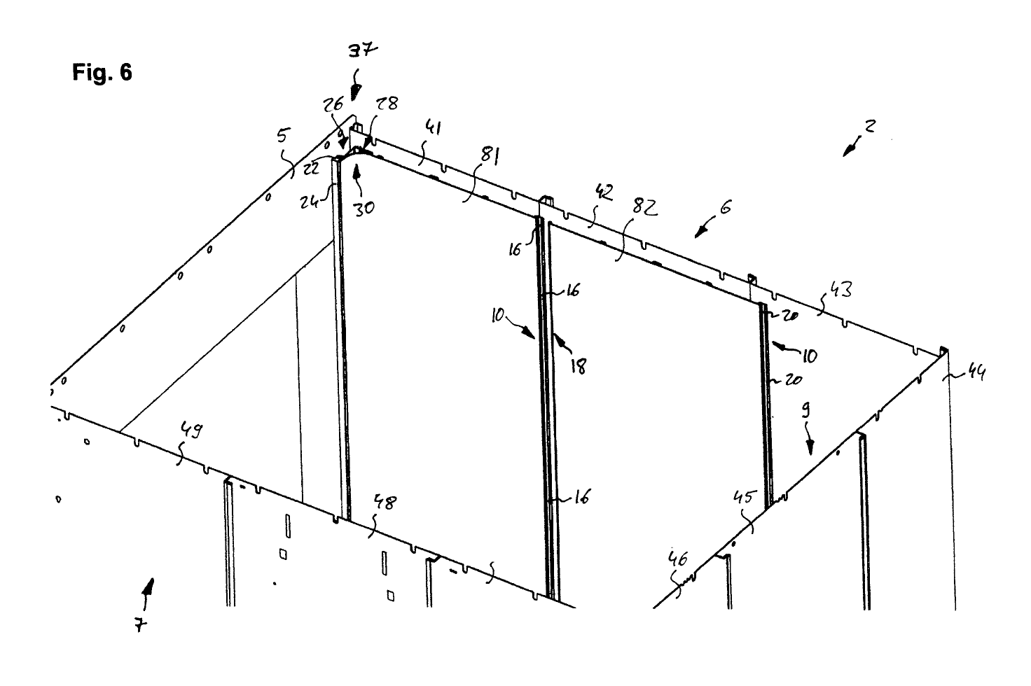

FIG. 6 shows a third step of installing elevator car lining panels according to an exemplary embodiment of the invention inside an elevator car.

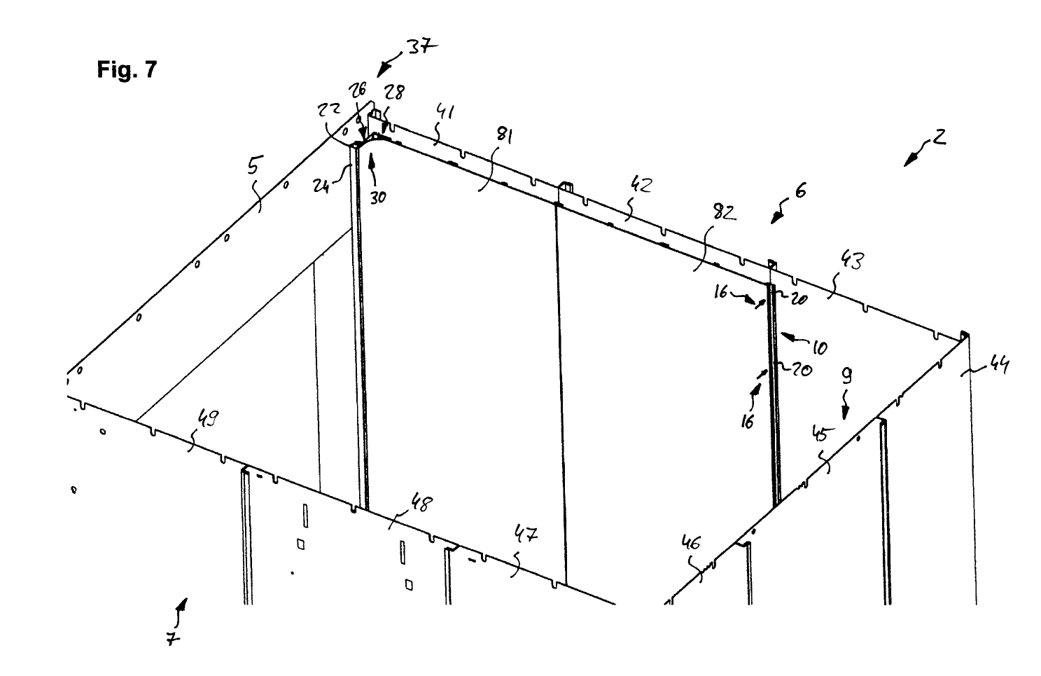

FIG. 7 shows a fourth step of installing elevator car lining panels according to an exemplary embodiment of the invention inside an elevator car.

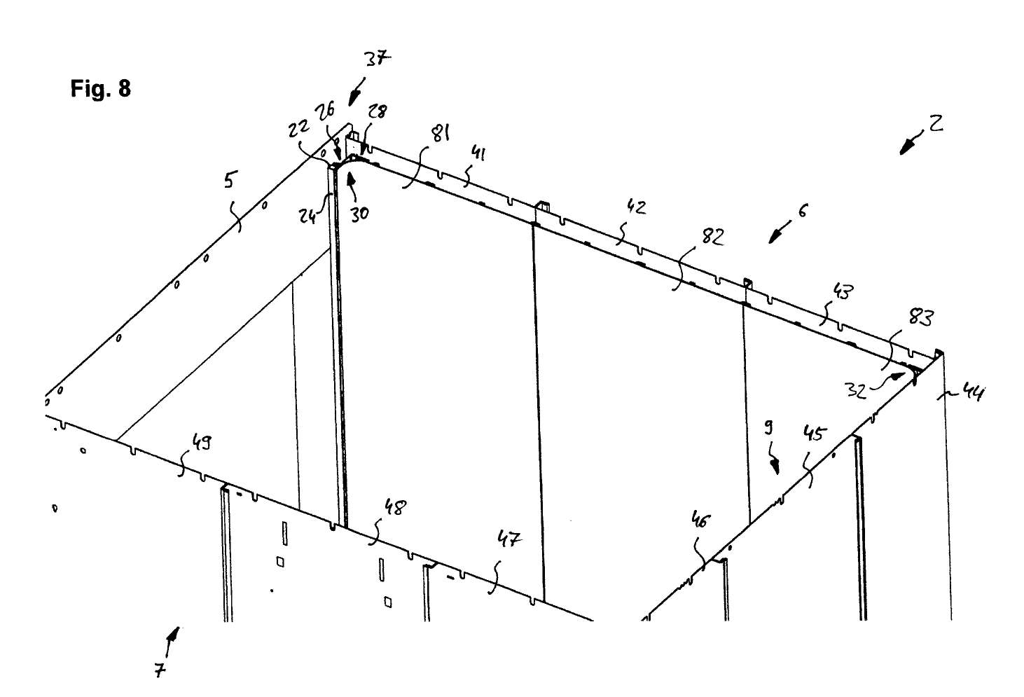

FIG. 8 shows a fifth step of installing elevator car lining panels according to an exemplary embodiment of the invention inside an elevator car.

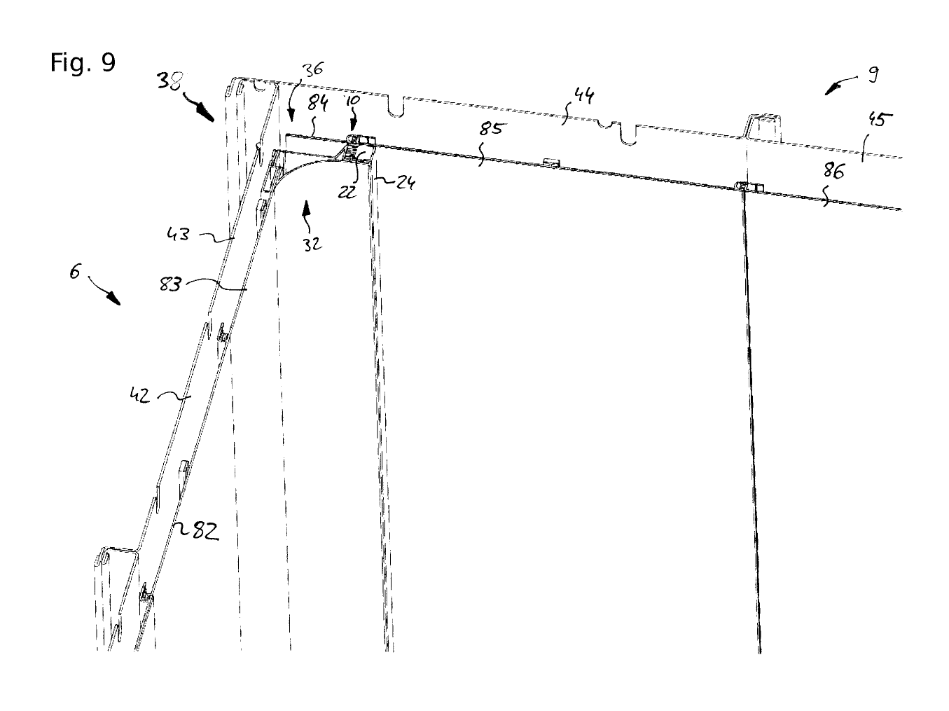

FIG. 9 shows a perspective view of a first rear corner of an elevator car comprising elevator car lining panels according to an exemplary embodiment of the invention.

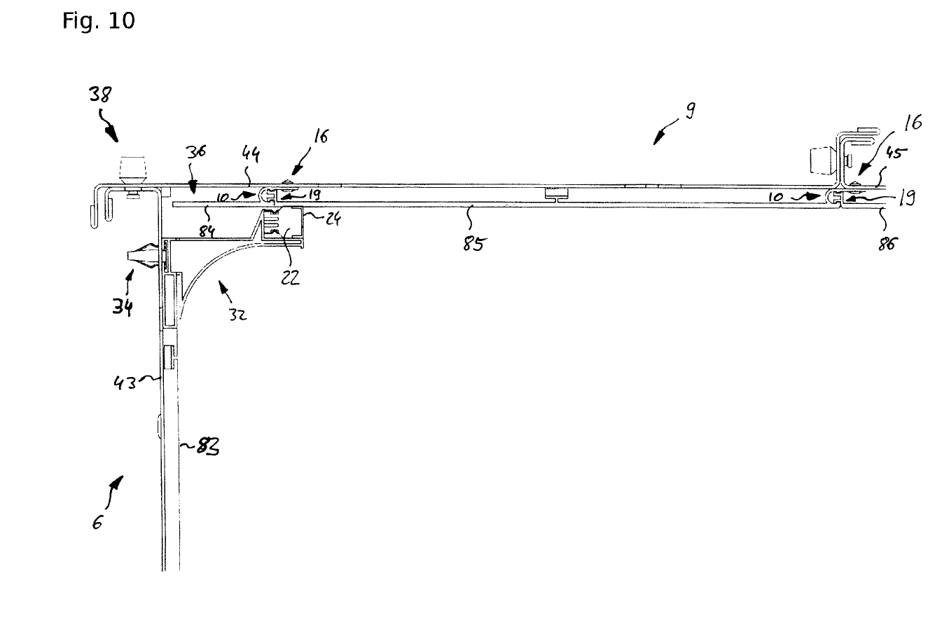

FIG. 10 shows a plan view of the first rear corner of an elevator car comprising elevator car lining panels according to an exemplary embodiment of the invention.

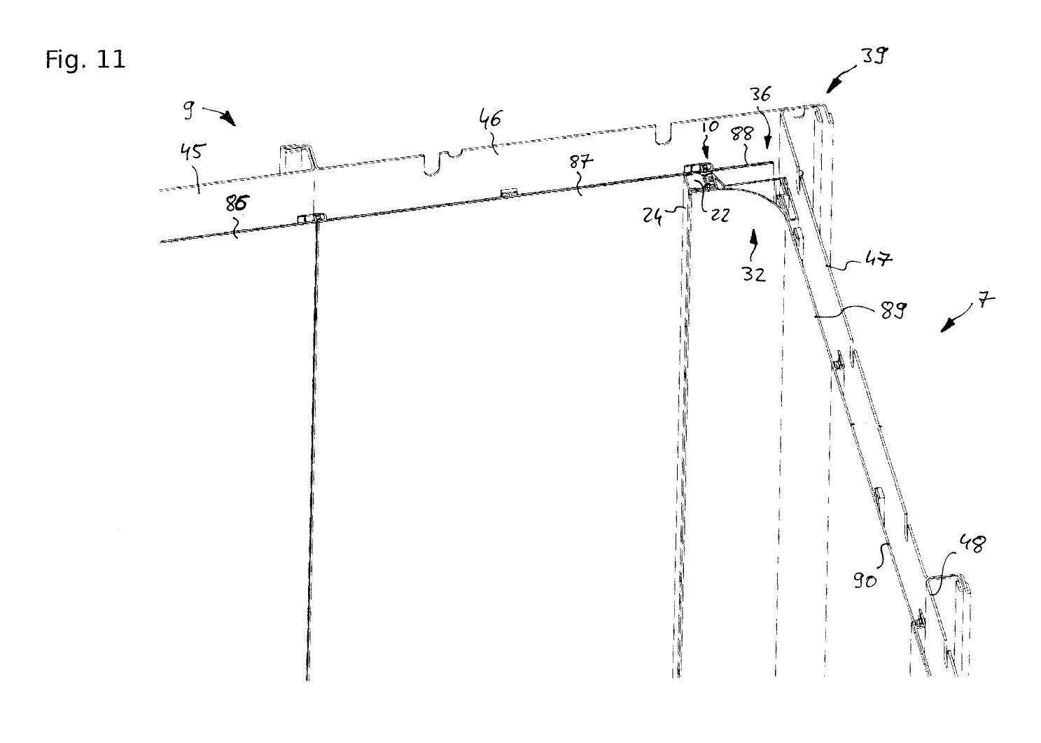

FIG. 11 shows a perspective view of a second rear corner of an elevator car comprising elevator car lining panels according to an exemplary embodiment of the invention.

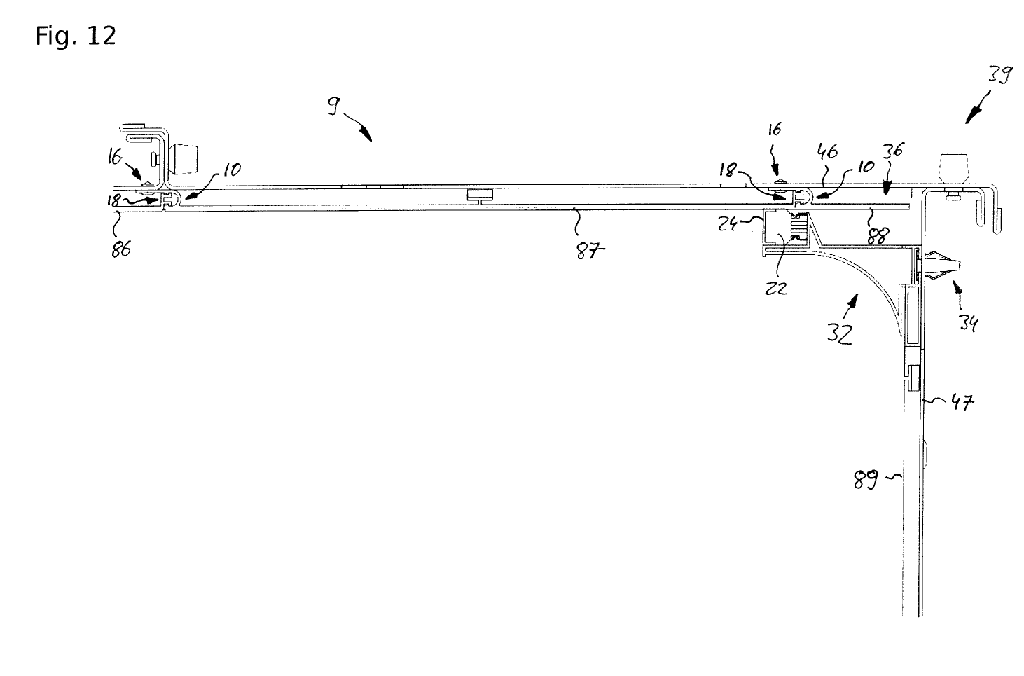

FIG. 12 shows a plan view of the second rear corner of an elevator car comprising elevator car lining panels according to an exemplary embodiment of the invention.

FIG. 1 illustrates a first step of installing an elevator car lining panel 81 according to an exemplary embodiment of the invention inside an elevator car 2.

The elevator car 2 comprises a plurality of structural panels 41-49 forming in combination with a front panel 5 an outer frame of the elevator car 2. The outer frame of the elevator car 2 includes a rear wall 9 and two opposing side walls 6, 7 defining an interior space 3 of the elevator car 2 for accommodating the passengers. The front panel 5 is configured for supporting at least one door (not shown) providing access to the interior space 3 of the elevator car 2.

In a first step, a first elevator car lining panel 81 is arranged inside the interior space 3 next to a first structural panel 41. The first elevator car lining panel 81 may be formed from an extruded sheet, in particular a plastic sheet or a metal sheet, which in particular may include aluminum. The sheet may be laminated with a cover layer on one or both sides. Particularly, the inner side may be laminated by a decor layer.

At the end facing the front panel 5 the first elevator car lining panel 81 comprises a first arcuate edge portion 30. The area of a front corner 37 formed by the front panel 5 and the adjacent first structural panel 41 is shown in an enlarged view in FIG. 2.

A receiving portion 26 is provided at an end of the first arcuate edge portion 30 facing away from the first structural panel 41 in a direction parallel to the front panel 5. Said receiving portion 26, which may be formed by bending the sheet material of the first elevator car lining panel 81, in particular is configured for accommodating at least one lighting element 22.

In the configuration shown in the figures, the sheet material of the first elevator car lining panel 81 is bend further in order to provide a supporting section 28 located between the first arcuate edge portion 30 and the adjacent first structural panel 41. The supporting section 28 supports and strengthens the first elevator car lining panel 81 in particular in an area next to the first arcuate edge portion 30.

At least one lighting element 22, which is configured for illuminating the interior of the elevator car 2, extends along the height of the first elevator car lining panel 81. The at least one lighting element 22 may comprise at least one of a neon tube, a fluorescent lamp and one or more LEDs, which provide a convenient and efficient light source. The light source(s) are covered by a cover element 24. The cover element 24 may be configured for mechanically protecting the light source(s) from being damaged. Additionally and/or alternatively the cover element 24 may be configured for distributing the light provided by the light source(s) of the at least one lighting element 22 in order to achieve a convenient illumination of the interior space 3 of the elevator car 2.

A first connection portion 10 is provided at an opposing side of the first elevator car lining panel 81 facing the rear wall 9. An enlarged view of said area is shown in FIGS. 3 and 4.

The first connection portion 10 comprises an arcuate portion 12 providing an open side facing the rear wall 9, and a straight portion 14 extending basically parallel to the planes of the first elevator car lining panel 81 and the adjacent first structural panel 41.

A first connection portion 10 having such a configuration may be formed e.g. by extruding the first elevator car lining panel 81 through an appropriate extrusion mask or by bending an originally flat sheet of material.

At least one opening 20, in particular a circular opening 20, is provided in the straight portion 14 of first connection portion 10. Such an opening 20 allows a fixing element 16, e.g. a bolt, a screw or a rivet, which is not shown in FIGS. 3 and 4, to pass through said first connection portion 10 of the first elevator car lining panel 81 and a corresponding opening 21 provided in an adjacent second structural panel 42 (see FIG. 1) providing a fixing structure which allows to securely fix the first elevator car lining panel 81 to the adjacent second structural panel 42.

FIG. 3 further shows an edge of an adjacent second elevator car lining panel 82 facing the first connection portion 10 of the first elevator car lining panel 81. A second connection portion 18 is formed at said edge of the second elevator car lining panel 82.

Said second connection portion 18 in particular includes a clipping mechanism 19 which is constituted by two elastic clipping arms 19a, 19b facing the first connection portion 10 of the adjacent first elevator car lining panel 81. The elastic clipping arms 19a, 19b are configured to elastically deform when entering into the open side of the arcuate portion 12 of the first connection portion 10. The elastic clipping arms 19a, 19b then clamp inside said arcuate portion 12 by resuming their original configuration providing a secure connection between the first and second elevator car lining panels 81, 82.

FIG. 4 shows a configuration of two adjacent elevator car lining panels 81, 82 securely fixed to each other.

In said connected configuration, the fixing elements 16 passing through the openings 20 provided in the first connection portion 10 are neither visible nor accessible, as they are covered by the second elevator car lining panel 82. This prevents passengers residing in the interior space 3 of the elevator car 2 from being injured or their clothing being damaged from contacting the fixing elements 16. Covering the fixing elements 16 further prohibits an unauthorized removal of the fixing elements 16 by passengers and provides an aesthetic configuration of the elevator car's interior space 3.

Another first connection portion 10 is provided at the right side of the second car lining panel 82, which is not shown in FIGS. 3 and 4. The first connection portion 10 of the second car lining panel 82 has the same configuration as the first connection portion 10 of the first car lining panel 81. The first connection portion 10 of the second car lining panel 82 allows for connecting a third car lining panel 83 (not shown in FIG. 4) to the second car lining panel 82 in the same way as the second car lining panel 82 is connected to the first car lining panel 81.

An exemplary sequence of installing a plurality of car lining panels 81, 82, 83 inside an elevator car 2 is illustrated in the following figures:

In FIG. 5 the first car lining panel 81 has been fixed to the adjacent first structural panel 41 by means of the fixing devices 16 passing through the openings 20 provided in the first connection portion 10 of the first car lining panel 81 and the openings 21 provided in the second structural panel 42.

In FIG. 6, a second elevator car lining panel 82 is arranged next to the first elevator car lining panel 81 in a configuration as it has been discussed with reference to FIG. 3.

In FIG. 7, said second car lining panel 82 has been connected with the first car lining panel 81 by inserting the second connection portion 18 of the second car lining panel 82 into the open side provided at the first connection portion 10 of the first car lining panel 81, as it has been discussed before with reference to FIG. 4.

Additionally, the first connection portion 10 of the second car lining panel 82 is fixed to an adjacent third structural panel 43 by means of fixing elements 16 passing through the openings 20 provided in the first connection portion 10 of the second car lining panel 82 and the adjacent third structural panel 43.

Finally, FIG. 8 depicts a configuration, in which a third elevator car lining panel 83 is arranged next to the second car lining panel 82 and attached to said second car lining panel 82 in the same way as it has been described before with respect to the second car lining panel 82.

Said third elevator car lining panel 83 comprises a second arcuate edge portion 32 having a similar but mirrored configuration as the first arcuate edge portion 30 of the first elevator car lining panel 81. Said second arcuate edge portion 32 is arranged in the corner 37 formed by the side wall 6 and the rear wall 9 of the elevator car 2, which is formed by the third and a fourth structural panels 43, 44.

As a result, in a configuration as it is shown in FIG. 8, one side wall 6 of the elevator car 2 is completely covered by a plurality of adjacent elevator car lining panels 81, 82, 83. Said elevator car lining panels 81, 82, 83 are securely connected to each other and to the structural panels 41, 42, 43 constituting the sidewall 6 of the elevator car 2. The fixing elements 16 fixing the elevator car lining panels 81, 82, 83 are not visible and not accessible, as they are covered by adjacent elevator car lining panels 81, 82, 83, respectively.

FIGS. 9 to 12 show a view into the interior space 3 of the elevator car 2 from a different perspective illustrating the configuration at the rear wall 9.

FIGS. 9 and 10 in particular show the configuration at a left rear corner 38 of the elevator car 2, and FIGS. 11 and 12 show the configuration at a right rear corner 39 of the elevator car 2.

As depicted in FIGS. 9 and 10, the third elevator car lining panel 83, which is positioned in the left rear corner 38 of the elevator car 2, comprises a receiving portion 24 for accommodating a lighting element 22, similar to the first elevator car lining panel 81, as it has been described before with respect to FIG. 2. In order to enhance the mechanical stability, the third elevator car lining panel 83 may be attached to the adjacent structural panel 43 using an additional fixation clip 34 which extends through the structural panel 43, as it is shown in FIG. 10.

The extension (width) of the third elevator car lining panel 83 in a direction parallel to the plane defined by the structural panels 4a-4c of the side wall 6, is set so that the third elevator car lining panel 83 does not abut against the structural panel 44 of the rear wall 9. Instead, the third elevator car lining panel 83 ends in some distance from the structural panel 44 of the rear wall 9 providing a gap 36 between the edge of the third elevator car lining panel 83 facing the rear wall 9 and the structural panel 44 of the rear wall 9.

A fourth elevator car lining panel 84 extending basically parallel to the structural panel 44 of rear wall 9 is arranged in said gap 36. Thus, the fourth elevator car lining panel 84 is arranged between the structural panel 44 of the rear wall 9 and the arcuate portion of the third elevator car lining panel 83.

The extension (width) of said fourth elevator car lining panel 84 in a dimension parallel to the plane of the structural panels 44-46 of the rear wall 9 is shorter than the extension (width) of the first to third elevator car lining panels 81-83 arranged parallel to the side wall 6. The dimension of the fourth elevator car lining panel 84 in the direction parallel to the rear wall 9 in particular is substantially equal to the dimension of the portion of the third elevator car lining panel 83 extending parallel to the rear wall 9. As a result, the fourth elevator car lining panel 84 is covered by the third elevator car lining panel 83 and not visible from the elevator car's 2 interior space 3.

The edge of said fourth elevator car lining panel 84 facing away from the side wall 6 (i.e. facing to the right side in FIGS. 9 and 10) is provided with a first connection portion 10. Said first connection portion 10 is formed identical to the first connection portions 10 of the first to third elevator car lining panels 81-83, as they have been described before.

The first connection portion 10 is fixed to the structural panel 44 of the rear wall 9 by means of at least one fixing element 16 (which is not shown in FIG. 9) in the same way as the first connection portions 10 of the first to third elevator car lining panels 81-83 are fixed to the structural panels 41-43 of the side wall 6.

A fifth elevator car lining panel 85 is arranged next to the fourth elevator car lining panel 84. The edge of the fifth elevator car lining panel 85 facing the fourth elevator car lining panel 84, which is shown on the left side in FIGS. 9 and 10, is provided with a second connection portion 12. Said second connection portion 12 is formed identical to second connection portions 12 of the first to third elevator car lining panels 81-83, as they have been described before. The second connection portion 12 of the fifth elevator car lining panel 85 is introduced into the first connection portion 10 of the fourth elevator car lining panel 84 for providing a secure connection between the fourth and fifth elevator car lining panels 84, 85.

The edge of the fifth elevator car lining panel 85 facing away form the fourth elevator car lining panel 84 (i.e. facing to the right side in FIGS. 9 and 10) is provided with a first connection portion 10 which allows to fix the fifth elevator car lining panel 85 to an adjacent structural panel 45 of the rear wall 9 by means of a fixing element 16. The first connection portion 10 of the fifth elevator car lining panel 85 allows to receive the second connection portion 18 of an adjacent sixth elevator car lining panel 86, which is arranged next to the fifth elevator car lining panel 85.

A similar configuration, which is mirrored with respect to an imaginary central plane extending parallel to the side walls 6, 7 through the center of the elevator car 2, is provided in the right rear corner 39 of the elevator car 2. This configuration is illustrated in FIGS. 11 and 12:

A seventh elevator car lining panel 87 and an eighth elevator car lining panel 88 correspond to the fifth and the fourth elevator car lining panels 85, 84 respectively, and a ninth and a tenth elevator car lining panel 89, 90 respectively correspond to the second and third elevator car lining panels 82, 83, which are located at the opposing sidewall 6.

With the structure of elevator car lining panels 81-86 according to exemplary embodiments of the invention, the side walls 6, 8 and the rear wall 9 of the elevator car 2 may be covered completely by elevator car lining panels 81-90. The elevator car lining panels 81-90 are securely attached to each other and/or to the structural panels 44-49 of the elevator car 2.

In the embodiments, which are illustrated in the figures, the elevator car lining panels 84-88, which are attached to the structural panels 44-46 forming the rear wall 9 of the elevator car 2, are not mechanically connected to the elevator car lining panels 81-83, 89, 90 arranged at the side walls 6, 7. This separation allows to compensate for mechanical tolerances and/or thermal expansion of the car lining panels 81-88 and avoids the generation of any undesirable mechanical stresses in the structure formed by the elevator car lining panels 81-89.

The skilled person, however, will easily understand that in an alternative configuration the car lining panels 84-88 attached to the structural panels 44-46 forming the rear wall 9 of the elevator car 2 may be mechanically connected to the elevator car lining panels 81-83, 89, 90 arranged at the side walls 6, 7 of the elevator car 2 by employing the same principles as they have been described before. In particular, the elevator car lining panels 83, 89 arranged in the rear corners 38, 39 of the elevator car 2 may be provided with additional connection portions 10, 12 which are configured for connecting the elevator car lining panels 83, 89 at the rear corners 38, 39 with the car lining panels 84-88 attached to the structural panels 44-46 of the rear wall 9. Alternatively or additionally, additional flexible or rigid connection means may be used for realizing said connection.

The skilled person will also easily understand that the number of adjacent structural panels 41-49 and elevator car lining panels 81-90 shown in the figures is only exemplary. Further exemplary embodiments of the invention may employ any number of adjacent structural panels 41-49 and elevator car lining panels 81-90 located at the side walls 6, 7 and the rear wall 9, respectively. Further, the extension (width) of the structural panels 41-49 may be different from the extension (width) of elevator car lining panels 81-90. This will result in a difference between the numbers of structural panels 41-43, 47-49 and the numbers of elevator car lining panels 81-83, 89, 90 arranged along each of the side walls 6, 7.

Further Embodiments:

A number of optional features are set out in the following. These features may be realized in particular embodiments, alone or in combination with any of the other features.

In an embodiment the at least one first connection portion extends along a first edge of the elevator car lining panel and/or the at least one second connection portion extends along a second edge of the elevator car lining panel, in particular in a vertical direction. Connection portions extending along the edges of the elevator car lining panels allow for a secure connection over the whole height of adjacent elevator car lining panels.

In an embodiment the first edge of the elevator car lining panel is located opposite to the second edge of the elevator car lining panel allowing to sequentially attach a plurality of elevator car lining panels to each other forming a row of adjacent elevator car lining panels, which are connected to each other.

In an embodiment each of the elevator car lining panels is formed from a single piece of sheet material. This allows to produce the elevator car lining panels easily and at low costs, e.g. by extrusion.

In an embodiment at least one of the first and second connection portions is formed by bending a sheet material. Bending is a cheap and reliable method for forming the connection portions. Bending in particular avoids the need of attaching an additional material to the elevator car lining panels when forming the connection portions.

In an embodiment the sheet material comprises a metal, in particular aluminum. Elevator car lining panels formed from metal are very fire retardant. This characteristic considerably enhances the safety of the elevator system. Aluminum is a light material. Thus, elevator car lining panels made of aluminum do not add much additional weight to the elevator car. A light elevator car is easier to move than a heavy elevator car. Thus, reducing the weight of the elevator car reduces the energy which is needed for operating the elevator system.

In an embodiment the sheet material of the elevator car lining panels is laminated in order to improve the mechanical and optical properties of the elevator car lining panels. By laminating the sheet material undesirable light reflections at the surface of the elevator car lining panels can be reduced or even completely suppressed. A sandwich structure comprising a laminated sheet material further may have an increased mechanical strength, in particular with respect to bending forces acting on the elevator car lining panel.

In an embodiment at least one of the first and second connection portions comprises a clipping mechanism which is configured for engaging with a corresponding connection portion provided at an adjacent elevator car lining panel. A clipping mechanism provides reliable and convenient means for securely connecting adjacent connection portions to each other.

In an embodiment the fixing structure comprises at least one opening configured for receiving at least one fixing element in order to pass through said opening. Such a combination of at least one opening and at least one corresponding fixing element allows to fix the elevator car lining panel securely to at least one structural panel of the elevator car.

In an embodiment any fixing elements passing through the openings provided in the at least one first connection portion are not visible and/or are not accessible when the at least one first connection portion is connected with a corresponding second connection portion of an adjacent elevator car lining panel. The fixing elements in particular may be covered by at least a portion of the second connection portion. This prevents passengers residing in the interior space of the elevator car from being injured or damaging their clothing by contacting the fixing elements. It further prohibits an unauthorized removal of the fixing elements by the passengers and it provides an aesthetic configuration of the elevator car's interior space.

In an embodiment the elevator car lining panel comprises at least one arcuate edge portion to be arranged in a vertically extending corner of the elevator car. An elevator car lining panel comprising an arcuate portion is very convenient to be arranged in a corner of the elevator car. An arcuate portion in particular avoids any sharp edges which may cause injury or damage.

In an embodiment the elevator car lining panel comprises a receiving portion which is configured for accommodating at least one lighting element.

In an embodiment the at least one lighting element comprises at least one of a neon tube, a fluorescent lamp and one or more LEDs for providing a convenient and efficient light source.

In an embodiment of an elevator car according to an exemplary embodiment of the invention at least one lighting element is arranged in the receiving portion of at least one elevator car lining panel. Arranging at least one lighting element in a receiving portion provided by an elevator car lining panel allows to conveniently illuminate the interior of the elevator car.

A method of assembling an elevator car according to a further exemplary embodiment of the invention additionally comprises the step of connecting a third elevator car lining panel with the first and/or second elevator car lining panel and attaching the third elevator car lining panel to at least one of the structural panels of the elevator car.

An additional (fourth) elevator car lining panel may be attached in the same way to the third elevator car lining panel etc. By sequentially attaching a plurality of elevator car lining panels, at least one wall of an elevator car may be covered completely by elevator car lining panels securely attached to each other.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the dependent claims.

### REFERENCES

2 elevator car

3 interior space of the elevator car

5 front panel

6, 7 side walls

9 rear wall

10 first connection portion

12 arcuate portion of the first connection portion

14 straight portion of the first connection portion

16 fixing element

18 second connection portion

19 clipping mechanism

19a, 19b clipping arms

20 opening provided in the first connection portion

21 opening provided in a structural panel

22 lighting element

24 cover element

26 receiving portion

28 supporting section

30 first arcuate edge portion

32 second arcuate edge portion

34 fixation clip

36 gap

37 front corner of the elevator car

38 left rear corner of the elevator car

39 right rear corner of the elevator car

41-48 structural panels

81-90 elevator car lining panels

1. An elevator car lining panel (81-90) configured to be attached to at least one structural panel (41-49) of an elevator car (2),
wherein the elevator car lining panel (81-90) comprises at least one first connection portion (10), which is configured for connecting with at least one corresponding second connection portion (18) of an adjacent elevator car lining panel (81-90) in order to fix two adjacent elevator car lining panels (81-90) with each other; and
wherein the at least one first connection portion (10) comprises a fixing structure allowing to fix the elevator car lining panel (81-90) to an adjacent structural panel (41-49) of the elevator car (2).

2. The elevator car lining panel (81-90) according to claim 1, wherein the at least one first connection portion (10) extends along a first edge of the elevator car lining panel (81-90) and/or the at least one second connection portion (18) extends along a second edge of the elevator car lining panel (81-90).

3. The elevator car lining panel (81-90) according to claim 2, wherein the first edge of the elevator car lining panel (81-90) is located opposite to the second edge of the elevator car lining panel (81-90).

4. The elevator car lining panel (81-90) according to claim 1, wherein at least one of the at least one first connection portion (10) and the at least one second connection portion (18) extend in a vertical direction.

5. The elevator car lining panel (81-90) according to claim 1, wherein the elevator car lining panel (81-90) is formed from a sheet material, in particular from a single piece of sheet material, wherein at least one of the first and second connection portions (10, 18) in particular is formed by bending the sheet material.

6. The elevator car lining panel (81-90) according to claim 5, wherein the sheet material comprises a plastic material or a metal, in particular aluminum, and/or is laminated.

7. The elevator car lining panel (81-90) according to claim 1, wherein at least one of the first and second connection portions (10, 18) comprises a clipping mechanism (19) which is configured to engage with at least one corresponding connection portion (18, 10) of an adjacent elevator car lining panel (81-90).

8. The elevator car lining panel (81-90) according to claim 1, wherein the fixing structure comprises at least one opening (20) which is configured for receiving at least one fixing element (16).

9. The elevator car lining panel (81-90) according to claim 8, being configured such that the fixing element (16) received in the opening (20) provided in the at least one first connection portion (10), is not visible and/or not accessible when the at least one first connection portion (10) is connected with a corresponding second connection portion (18) of an adjacent elevator car lining panel (81-90).

10. The elevator car lining panel (81-90) according to claim 1, comprising at least one arcuate edge portion (30, 31) which is configured to be arranged in a vertically extending corner of the elevator car (2).

11. The elevator car lining panel (81-90) according to claim 1, comprising a receiving portion (26) which is configured for accommodating at least one lighting element (22).

12. An elevator car, comprising at least one structural panel (41-49) and at least one elevator car lining panel (81-90) according to claim 1, wherein the least one elevator car lining panel (81-90) is attached to the at least one structural panel (41-49) of the elevator car (2).

13. The elevator car according to claim 12, comprising at least one elevator car lining panel (81-90) and at least one lighting element (22) arranged in the receiving portion (26).

14. A method of assembling an elevator car (2) comprising the steps of:
a) assembling a plurality of structural panels (41-49) for forming an elevator car (2);
b) attaching a first elevator car lining panel (81) according to claim 1 to at least one of the structural panels (41-49);
c) connecting a second elevator car lining panel (82) with the first elevator car lining panel (81) and attaching the second elevator car lining panel (82) to at least one of the structural panels (41-49).

15. The method of assembling an elevator car (2) according to claim 14, further comprising the step of
d) connecting a third elevator car lining panel (83) with the first or second elevator car lining panel (81, 82) and attaching the third elevator car lining panel (83) to at least one of the structural panels (41-49).
